(19) United States
(12) Patent Application Publication
(10) Pub. No.: US 2019/0246468 A1
(43) Pub. Date: Aug. 8, 2019

(54) CONTROL DEVICE FOR LIGHT EMITTING ELEMENT, CONTROL METHOD FOR LIGHT EMITTING ELEMENT, LIGHTING APPARATUS

(71) Applicant: STANLEY ELECTRIC CO., LTD., Tokyo (JP)

(72) Inventor: Toshio YOKOBORI, Tokyo (JP)

(73) Assignee: STANLEY ELECTRIC CO., LTD., Tokyo (JP)

(21) Appl. No.: 16/267,140

(22) Filed: Feb. 4, 2019

(30) Foreign Application Priority Data
Feb. 7, 2018 (JP) 2018-020352

(51) Int. Cl. H05B 33/08

(52) U.S. Cl. CPC H05B 33/0815; H05B 33/089; H05B 33/0851

(57) ABSTRACT

To improve the accuracy of the outgoing light intensity of the light emitting element by performing pulse width modulation. A control device for controlling a light emitting element by performing pulse width modulation includes a DC-DC converter for supplying voltage to the light emitting element, a setting unit that sets a control value for the pulse width modulation in the DC-DC converter, a detection unit that detects an actual value of an ON time period which is a period during which the current flowing through the light emitting element is relatively high, and a correction unit for correcting the control value set by the setting unit so as to reduce the difference between an expected value of the ON time period corresponding to the control value and the actual value of the ON time period detected by the detection unit.

### BACKGROUND OF THE INVENTION

### Field of the Invention

The present invention relates to a lighting control technique for a light emitting element such as an LED.

### Description of the Background Art

Japanese Patent No. 6201700 discloses a headlight apparatus for a vehicle having a plurality of light sources where outgoing light intensities (luminous intensities) of the plurality of light sources are individually controlled, and as each of the light sources, a LED lamp is disclosed.

In the light sources using LEDs as described above, one of the methods for controlling the intensity of the outgoing light of the LEDs is to perform pulse width modulation to the voltage supplied to the LEDs. In this case, the outgoing light intensity can be controlled by increasing or decreasing the duty ratio of the voltage.

Here, when controlling the intensity of the outgoing light of the LEDs by performing pulse width modulation, there is a time lag between the time when the voltage is applied to the LEDs and the time when the electric current actually flows to the LEDs. This is due to the parasitic capacitance and parasitic resistance present on the circuit including the LEDs. In many cases, this time lag is as small as several micro seconds (μs).

However, when the outgoing light intensity of the LEDs is set extremely low, the influence of the lime lag cannot be ignored in some cases. This is because the ON time period (hereinafter referred to as ON time), which is the period during which the voltage is applied, becomes so short that the ratio of the time lag to the ON time becomes high.

Thus, the actual ON time is likely to become shorter than the originally intended ON time set for obtaining the specified outgoing light intensity, and there is a problem that the outgoing light intensity does not reach the specified value. Such a problem is not limited to a vehicle headlight apparatus but may also occur in a lighting apparatus using a light emitting element such as an LED.

In a specific aspect, it is an object of the present invention to provide a technique capable of improving the accuracy of the outgoing light intensity from the light emitting element when performing pulse width modulation.

### SUMMARY OF THE INVENTION

[1] A control device according to one aspect of the present invention is (a) a control device for controlling a light emitting element by performing pulse width modulation including (b) a DC-DC converter for supplying voltage to the light emitting element, (c) a setting unit that sets a control value for the pulse width modulation in the DC-DC converter, (d) a detection unit that detects an actual value of an ON time period which is a period during which electric current flowing through the light emitting element is relatively high, and (e) a correction unit for correcting the control value set by the setting unit so as to reduce the difference between a specified value of the ON time period corresponding to the control value and the actual value of the ON time period detected by the detection unit.

[2] A control method according to one aspect of the present invention is (a) a control method for controlling the light emitting element by performing pulse width modulation including (b) a first step for setting a control value of the pulse width modulation in a DC-DC converter that supplies a voltage to the light emitting element, (c) a second step for detecting an actual value of an ON time period which is a period in which electric current flowing through the light emitting element is relatively high, and (d) a third step for correcting the control value so as to reduce the difference between a specified value of the ON time period corresponding to the control value and the actual value of the ON time period detected by the detecting unit.

[3] A lighting apparatus according to one aspect of the present invention includes the above-described control device and a light emitting element controlled by the control device.

According to the above configurations, it is possible to improve the accuracy of the outgoing light intensity of the light emitting element by performing pulse width modulation.

### BRIEF DESCRIPTION OF THE DRAWINGS

FIG. 1 is a diagram showing a configuration of a driving device of a light emitting element according to one embodiment.

FIGS. 2A and 2B are conceptual waveform diagrams showing electric current flowing through the light emitting element.

FIG. 3 is a flowchart showing the operation procedure of the control unit.

FIG. 4 is a conceptual diagram showing a configuration example of a vehicular lamp.

### DESCRIPTION OF THE PREFERRED EMBODIMENTS

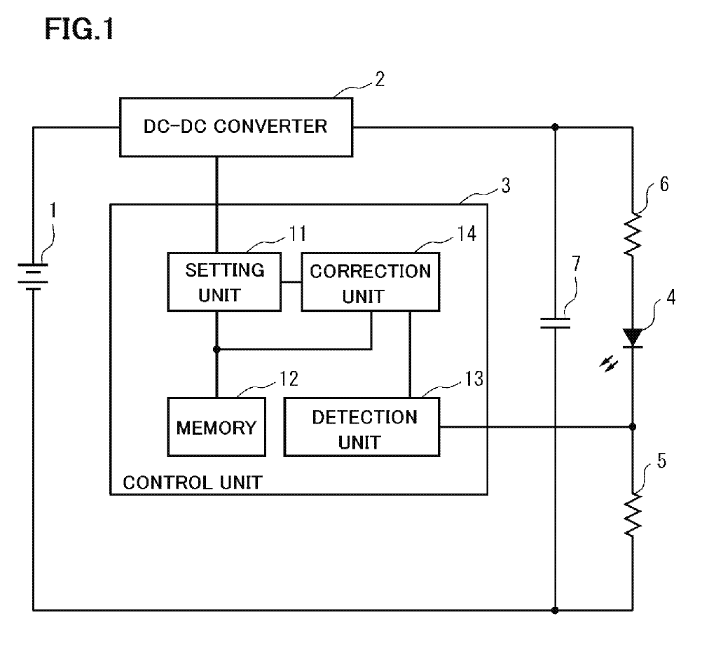

FIG. 1 is a diagram showing a configuration of a driving device of a light emitting element according to one embodiment. The driving device (control device) of the light emitting element shown in the figure controls the lighting state of the light emitting element by receiving power from the power source 1, and is configured to includes a DC-DC converter 2, a control unit 3, a light emitting element 4, and a current detection resistance element 5. Here, resistance 6 in the circuit represents a parasitic resistance, and capacitor 7 represents a parasitic capacitance.

The DC-DC converter 2 is of a switching type and supplies to the light emitting element 4 a pulse width modulated DC voltage with a duty ratio based on a control signal provided from the control unit 3. The light intensity of the light emitting element 4 can be controlled by the duty ratio of this DC voltage.

The control unit 3 generates a control signal for setting the duty ratio of the DC voltage in the DC-DC converter 2 and supplies it to the DC-DC converter 2.

The light emitting element 4 is an LED, for example, and receives voltage from the DC-DC converter 2 and emits light. Here, although only one light emitting element 4 is shown in the figure, a plurality of light emitting elements may be connected in series, in parallel, or in series and in parallel.

The current detection resistance element 5 is connected in series with the light emitting element 4, and is used for the control unit 3 to detect the electric current flowing through the light emitting element 4.

Here, the “control device for controlling a light emitting element” is configured to include the DC-DC converter 2, the control unit 3, and the current detection resistance element 5.

The above-described control unit 3 is realized, for example, by executing a predetermined operation program in a microcomputer, and is configured to include a pulse width modulation (hereinafter often abbreviated as PWM) signal generation unit 11 (referred to as “a setting unit”), a memory 12, a PWM output time detection unit 13 (referred to as “a detection unit”), and a correction value setting unit 14 (referred to as “a correction unit”).

The PWM signal generation unit 11 generates a control signal for setting the duty ratio (the control value) of the DC voltage generated in the DC-DC converter 2 and supplies it to the DC-DC converter 2. Note that a pulse width may be used instead of the duty ratio as the control value.

The memory 12 is a non-volatile memory, for example, and stores data indicating a specified value of the ON time, which is a period in which electrical current flowing through the light emitting element 4 is relatively high when voltage is supplied to the light emitting element 4 based on the duty ratio indicated by the control signal generated by the PWM signal generating section 11. More specifically, the memory 12 stores a data table indicating the correspondence between each duty ratio and the specified value of the ON time with respect to each duty ratio. The term “specified value” as used herein refers to the length of the ON time period which is specified from the design or theoretical point of view.

The PWM output time detection unit 13 detects the actual value (the PWM output time) of the ON time, which is a period during which the electrical current flowing through the light emitting element 4 is relatively high, by measuring the electrical current flowing through the current detecting resistance element 5.

The correction value setting unit 14 reads out from the memory 12 the specified value (data) of the ON time corresponding to the duty ratio indicated by the control signal generated by the PWM signal generation unit 11. The correction value setting unit 14 then calculates the difference between the specified value of the ON time and the PWM output time detected by the PWM output time detecting unit 13 and sets a correction value for correcting the duty ratio so that the PWM output time becomes equal to or becomes close to the specified value of the ON time. This correction value is provided to the PWM signal generation unit 11. Thereby, the control signal generated by the PWM signal generating section 11 is corrected.

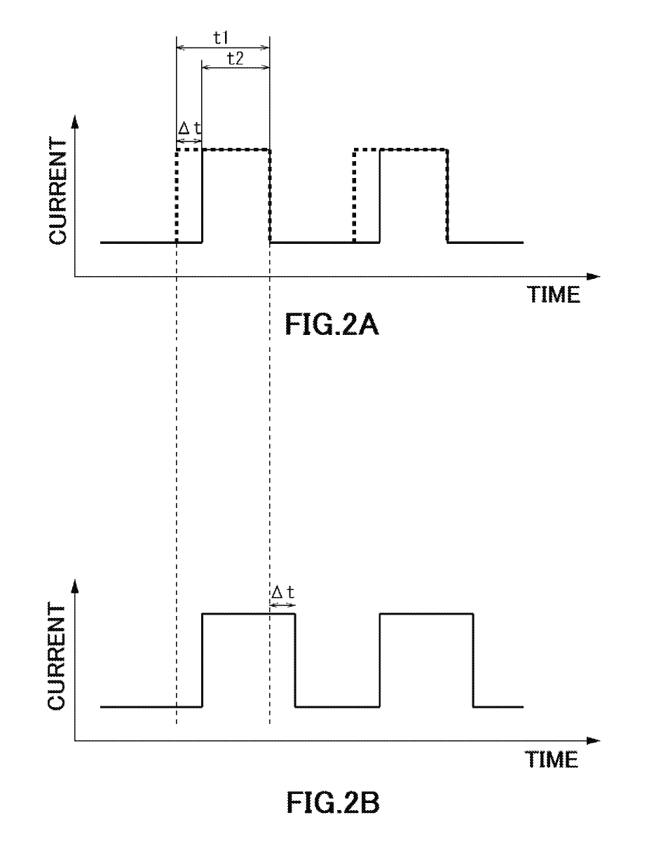

FIGS. 2A and 2B are conceptual waveform diagrams showing electric current flowing through the light emitting element. The operation of the control unit 3 will now be described with reference to these waveform diagrams. In FIG. 2A, assuming that the specified value of the ON time of the electrical current flowing through the light emitting element 4 is t1 (refer to the waveform indicated by the dotted line in the figure), delay occurs in the PWM output time t2 which is the actual value of the ON time (refer to the waveform indicated by the solid line in the figure) due to the influence of parasitic capacitance and parasitic resistance. Here, the PWM output time detection unit 13 detects the PWM output time t2. Further, the correction value setting unit 14 reads out from the memory 12 the specified value t1 of the ON time and calculates the difference Δt (delta t) between the specified value t1 and the PWM output time t2 detected by the PWM output time detection unit 13. Then, the correction value setting unit 14 sets the correction value so that the PWM output time, which is the actual ON time, is increased by the amount of time corresponding to the difference Δt, and provides it to the PWM signal generation unit 11. The PWM signal generation unit 11 sets the duty ratio reflecting the correction value. As a result, as shown in FIG. 2B, the duty ratio set by the PWM signal generation unit 11 is corrected so that the PWM output time is increased by the amount of time corresponding to the difference Δt.

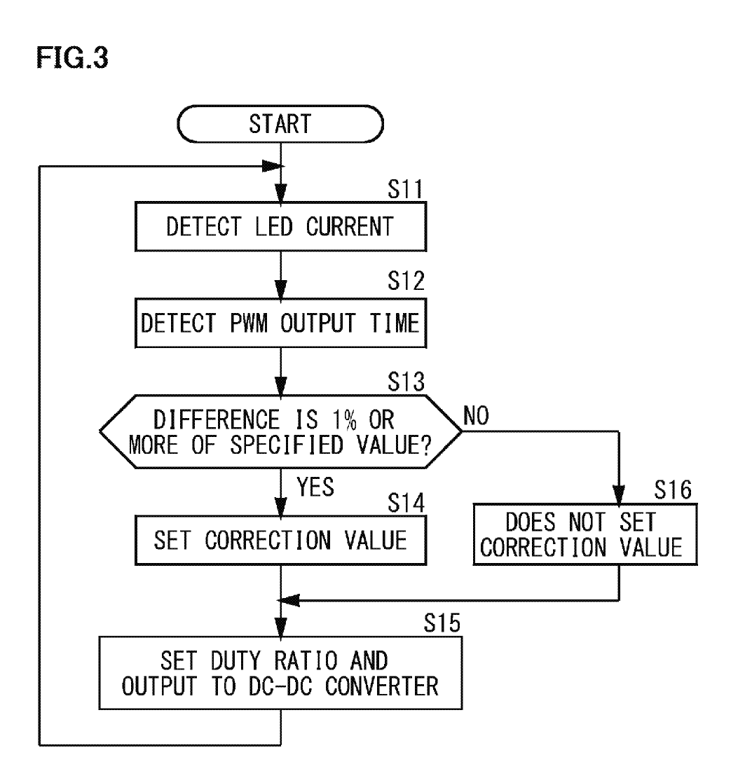

FIG. 3 is a flowchart showing the operation procedure of the control unit. The control method performed by the control unit will now be described below with reference to this flowchart. It should be noted that the order of each process shown in the flowchart can be appropriately changed as long as there is no contradiction in the operation procedure, and the order of the process is not limited to the one shown in the flowchart.

The PWM output time detection unit 13 in the control unit 3 detects the LED current flowing through the current detection resistance element 5 (step S11), and further detects the PWM output time from the waveform of the LED current (step S12).

Specifically, the LED current is converted into a voltage by the current detecting resistance element 5, and the PWM output time t2 (refer to FIG. 2A) is detected based on the waveform of the voltage.

Next, the correction value setting unit 14 reads out from the memory 12 the specified value t1 of the ON time corresponding to the duty ratio indicated by the control signal generated by the PWM signal generation unit 11, and calculates the difference (error amount) between the ON time t1 of this specified value and the PWM output time t2 which is the actual ON time detected by the PWM output time detection unit 13. Then, the correction value setting unit 14 determines whether or not the difference is 1% or more of the specified value t1 (step S13). It should be noted that the criterion “1%” is merely an example and can be set to an appropriate value in accordance with the actual situation.

When the error amount is 1% or more (step S13; YES), the correction value setting unit 14 sets a correction value so that the PWM output time t2 becomes equal to or close to the specified value according to the difference between the specified value t1 and the PWM output time t2, and outputs the correction value to the PWM signal generation unit 11 (step S14). Upon receiving the correction value, the PWM signal generation unit 11 sets a duty ratio (or a pulse width modulation width) reflecting the correction value, and outputs the control signal indicating the duty ratio (or the pulse width modulation width) to the DC-DC converter 2 (step S15).

On the other hand, when the error is less than 1% (step S13; NO), the correction value setting unit 14 does not set a correction value (step S16). Here, the process of not setting a correction value also includes setting the correction value to 0. In this case, the PWM signal generation unit 11 sets a duty ratio (or a pulse width modulation width) which does not include the correction value, and outputs a control signal indicating the duty ratio (or the pulse width modulation width) to the DC-DC converter 2 (step S15).

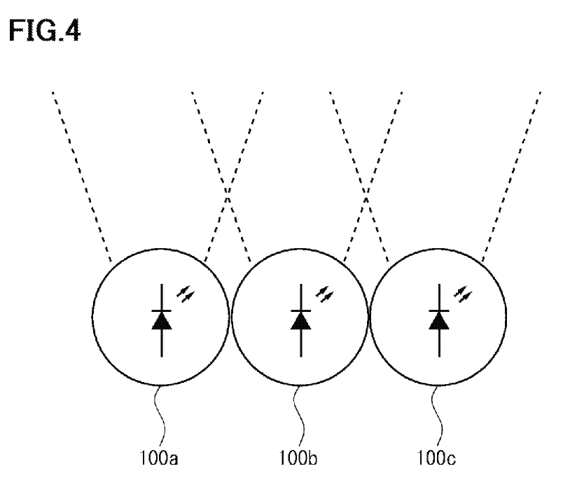

FIG. 4 is a conceptual diagram showing a configuration example of a vehicular lamp that is configured using the light emitting elements and the driving devices thereof according to the above-described embodiment. The illustrated vehicular lamp includes three units 100a, 100b, and 100c. Each of the units 100a, 100b, and 100c includes the above-described light emitting element and its driving device (refer to FIG. 1), and it is possible to irradiate light of each unit independently and to control the outgoing light intensity independently as well. According to such a vehicular lamp, it is possible to control the outgoing light intensity of each unit with high accuracy.

According to the embodiment as described above, it is possible to improve the accuracy of the outgoing light intensity of the light emitting element by performing pulse width modulation.

It should be noted that this invention is not limited to the subject matter of the foregoing embodiment, and can be implemented by being variously modified within the scope of the present invention as defined by the appended claims. For example, in the above-described embodiment, for the purpose of making the description easy to understand, a case where the correction of duty ratio is ideally performed has been described. However, in reality, the advantageous effect of the present invention can also be achieved not only in the case where the difference Δt of the ON time is completely corrected but also in a case where the difference Δt of the ON time becomes smaller.

Further, although a vehicular lamp is shown as an application example of the present invention in the above-described embodiment, the application of the present invention is not limited thereto, and may be applied to various lighting apparatus (or light sources) using a light emitting element.

What is claimed is:

1. A control device for controlling a light emitting element by performing pulse width modulation comprising:
a DC-DC converter for supplying voltage to the light emitting element,
a setting unit that sets a control value for the pulse width modulation in the DC-DC converter,
a detection unit that detects an actual value of an ON time period which is a period during which the current flowing through the light emitting element is relatively high, and
a correction unit for correcting the control value set by the setting unit so as to reduce the difference between a specified value of the ON time period corresponding to the control value and the actual value of the ON time period detected by the detection unit.

2. The control device for controlling the light emitting element according to claim 1,
further comprising a memory which stores data indicating the correspondence between the control value and the specified value of the ON time period,
wherein the correction unit corrects the control value by obtaining the specified value of the ON time period from the memory.

3. The control device for controlling the light emitting element according to claim 1,
wherein the difference between the specified value of the ON time period and the actual value of the ON time period is generated by a parasitic resistance and/or a parasitic capacitance on a circuit including the light emitting element.

4. The control device for controlling the light emitting element according to claim 2,
wherein the difference between the specified value of the ON time period and the actual value of the ON time period is generated by a parasitic resistance and/or a parasitic capacitance on a circuit including the light emitting element.

5. A control method for controlling a light emitting element by performing pulse width modulation comprising:
a first step for setting a control value of the pulse width modulation in a DC-DC converter that supplies a voltage to the light emitting element,
a second step for detecting an actual value of an ON time period which is a period in which the current flowing through the light emitting element is relatively high, and
a third step for correcting the control value so as to reduce the difference between a specified value of the ON time period corresponding to the control value and the actual value of the ON time period detected by the second step.

6. A lighting apparatus comprising:
the control device for controlling the light emitting element according to claim 1, and
a light emitting element controlled by the control device.
